(19) United States
(12) Patent Application Publication
(10) Pub. No.: US 2014/0368797 A1
(43) Pub. Date: Dec. 18, 2014

(54) METHODS AND APPARATUS FOR REDUCING GHOST IMAGES IN REFLECTIVE IMAGER-BASED PROJECTORS

(71) Applicant: Texas Instruments Incorporated, Dallas, TX (US)

(72) Inventors: John M. Ferri, Allen, TX (US); Patrick R. Destain, Allen, TX (US)

(21) Appl. No.: 13/927,842

(22) Filed: Jun. 26, 2013

Related U.S. Application Data
(60) Provisional application No. 61/834,131, filed on Jun. 12, 2013.

(51) Int. Cl. H04N 5/74

(52) U.S. Cl. CPC H04N 5/7458
USPC 353/20; 353/121

(57) ABSTRACT

An image projection system (300, 400) uses a polarized illumination source (306) in conjunction with a linear polarizer (314) located before and a quarter-wave retarder (312) located after an imager field lens 118 along a projection optical axis (216) between a spatial light modulator reflective imager (120) and a projection lens (122). The combination serves to block illumination light (210a) reflected off the imager field lens (314) and other optics (408, 411), while passing illumination light (210c) modulated by ON-state reflector elements of the reflective imager 120. The reduction of ghost reflections and stray light improves dark state (OFF-state reflector element) contrast.

This application claims the benefit of Provisional Application No. 61/834,131 filed Jun. 12, 2013, the entirety of which is incorporated by reference herein.

### BACKGROUND

This relates generally to image projection systems; and, in particular, to image projection systems using a reflective imager illuminated by light transmitted through a field lens.

FIG. 1 shows a conventional projection illumination system 100 as described in U.S. Patent Application Pub. No. 2005/0140940, incorporated herein by reference. System 100 includes a light source 106 that directs light 104 to a tunnel integrator 102. An elliptical reflector 108 is used to increase the amount of light reaching the input end 110 of the tunnel integrator 102. Light passing from the output end 116 of the tunnel integrator 102 is transmitted through an integrator field lens 113 to a relay lens 114 and then through an imager field lens 118 to a reflective imager 120. (Imager field lens 118 is the field lens closest to reflective imager 120.) The reflective imager 120 may, for example, be a microelectromechanical system (MEMS) imager such as a Texas Instruments DLP® digital micromirror device (DMD) spatial light modulator (SLM) that uses an array of pixel mirror elements to direct selected portions of the incoming light beam back through the imager field lens 118 to a projection lens system 122. In the illustrated arrangement, an aperture stop 121 is located in the projection lens system 122. The reflective imager 120 may be used in a field sequential color mode by placing a color selector 126, such as a color wheel or the like, along the optical path between the light source 106 and the projection screen 124. In the illustrated embodiment, the color selector 126 is disposed close to the input end 110 of the tunnel integrator 102. A typical light source 106 used in a conventional color wheel system of the type described is a high intensity xenon lamp white light source.

Reflective imager-based projectors may be subject to low screen image contrast when using a field lens approach for illumination as described. The cause of the problem is illumination light reflected off of the imager field lens optics that is captured by the projection lens optics and travels to the screen as stray light. This unwanted light can be seen when the reflective imager is set to the dark state and may significantly lower the contrast of the system. The stray light reflections are particularly prevalent in field lens illumination architectures as illustrated in the schematic representation of an image projection system 200 given in FIG. 2.

As shown in FIG. 2, a portion 210a of light 210 directed from the illumination light source 206 via illumination and homogenization optics 208 (shown as elements 102, 113, 114 in FIG. 1) through imager field lens 118 is incident on reflective imager 120, such as a DMD or other MEMS imager. The reflective imager 120 spatially modulates the incident light portion 210a according to individual reflector element settings determined based on data (viz., color/intensity data) received for corresponding individual image pixels of an image to be projected. Light 210c modulated by reflective imager 120 is directed in the opposite direction (relative to projection optical axis 216) through imager field lens 118 toward projection lens system 122 for projection onto an imaging surface, such as projection screen 124. Some of light source illumination light 210 directed at imager field lens 118 is reflected off imager field lens 118. Because of the curved surface nature of imager field lens 118, a portion 210b is reflected into the pupil of projection lens system 122 and imaged as stray light ghost reflections onto screen 124.

U.S. Pat. No. 7,760,437 discloses a projector having a projection lens unit including an optical lens adjacent a micromirror device and a light shielding plate for covering bias light to prevent formation of a ghost image in the projected image. U.S. Pat. No. 6,783,246 and U.S. Patent Application Pub. Nos. 2002/0057418 and 2002/0105622 disclose approaches for ghost light rejection through redirection of ghost reflections. Other reflective imager devices, such as reflective LCD projection displays (also known as liquid crystal on silicon or LCoS), are concerned with reflections returning from the projection lenses and not concerned with ghost images created by illumination light. U.S. Pat. No. 5,268,775 discloses a method to reduce projection lens ghost imaging using a quarter-wave retarder between a polarizer or polarizing beam splitter and a projection lens. Illumination for polarization rotating reflective imagers (LCoS), such as described in U.S. Pat. No. 6,478,429, place a linear polarizer in the illumination beam and have a linear polarizer in the projection path for illumination input when the device itself rotates the polarization state to modulate the brightness of pixels.

### SUMMARY

Methods and apparatus are provided for reducing the problem of ghost or stray light reflections in reflective imager-based projectors created by optics in the illumination light path resulting in loss of dark state contrast.

Described example embodiments use a polarized illumination source in conjunction with a one-quarter wavelength retarder (quarter-wave retarder) before and a linear polarizer after the imager field lens in the projection light path to block illumination light reflected off the imager field lens or other optics while passing illumination light modulated by the reflective imager.

### BRIEF DESCRIPTION OF THE DRAWINGS

FIG. 1 shows a conventional projection illumination system.

FIG. 2 illustrates reflection ghost imaging in an image projection system using an illumination system as shown in FIG. 1.

FIG. 3 shows an example configuration of an image projection system embodying principles of the invention.

FIG. 4 shows an example modified configuration of an image projection system embodying principles of the invention.

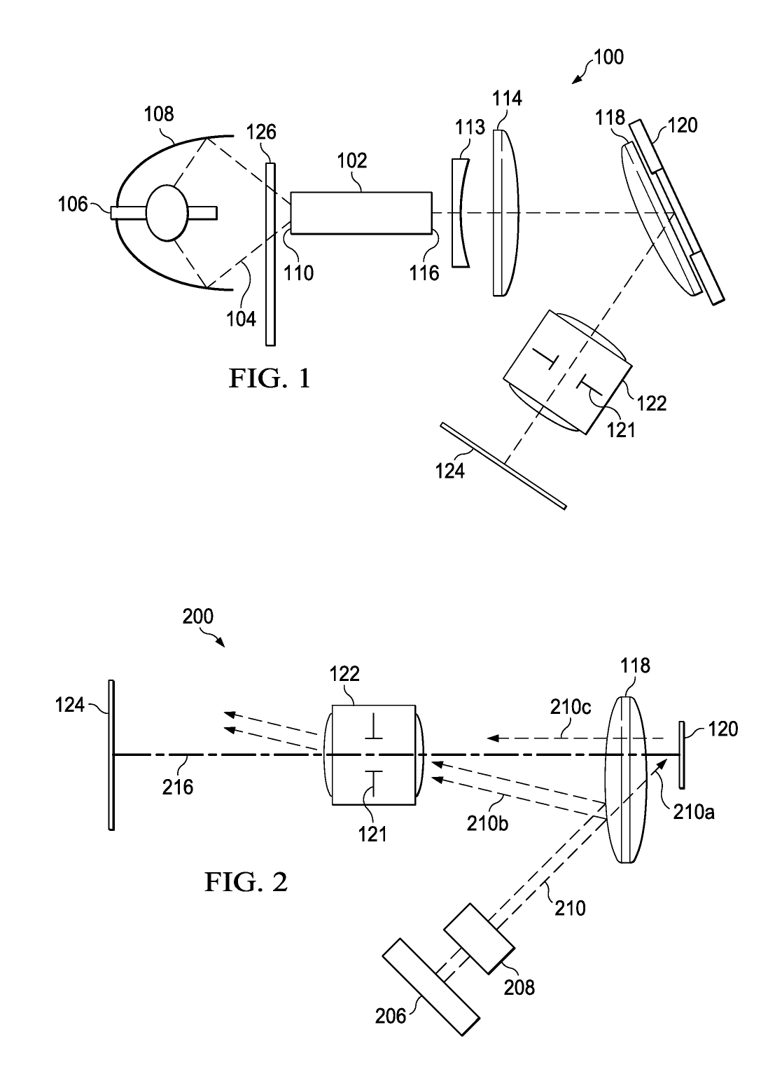

### DETAILED DESCRIPTION OF EXAMPLE EMBODIMENTS

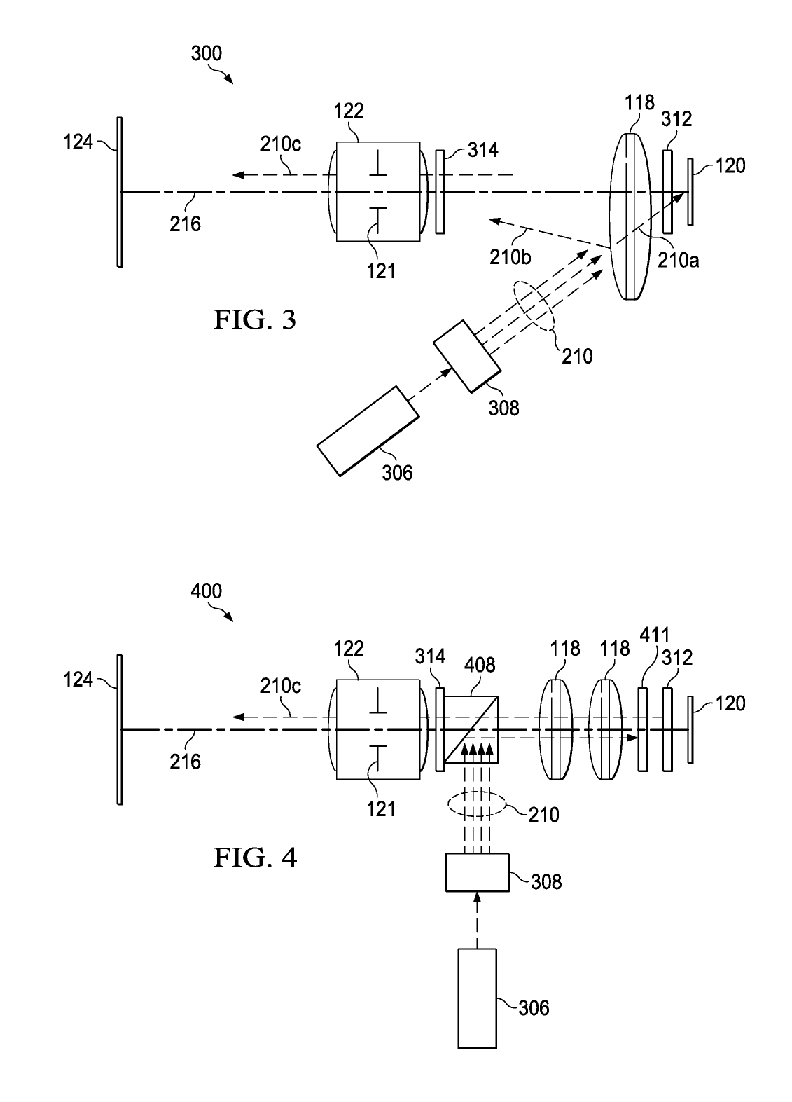

FIG. 3 shows an example embodiment of an image projection system 300 that addresses the problem of ghost or stray light reflections created by optics in the illumination path resulting in loss of dark state contrast. The image projection system 300 uses a polarized illumination source 306 in conjunction with a one-quarter wavelength retarder 312 and a linear polarizer 314 located before and after an imager field lens 118 in alignment with an optical axis 216 of the projection lens or projection path of illumination light modulated by a reflective imager 120. This combination serves to block illumination light reflected off the field lens or other optics while passing illumination light modulated by the reflective imager 120. The reduction of ghost reflections and stray light results in significantly improved dark state contrast. The approach is particularly applicable to very small projectors where field lens projection architectures offer cost and size advantages.

As shown in FIG. 3, system 300 includes a polarized light source 306 that directs light 210 via an illumination and homogenization optics 308 to an imager field lens 118. The polarized light source 306 may, for example, be a polarized laser or LED light source. Light integration and/or other optics may be located between light source 306 and imager field lens 118. A portion 210a of polarized illumination light 210 from light source 306 is transmitted through imager field lens 118 to a reflective imager 120. The reflective imager 120 spatially modulates the incident light portion 210a according to individual reflector element settings determined based on data (viz., color/intensity data) for corresponding individual image pixels of an image to be projected. The reflective imager 120 may, for example, be a Texas Instruments DLP® digital micromirror device (DMD) that uses an array of individually settable pixel mirror elements for spatial modulation of the incident light. Selected portions 210c of the modulated incident light 210a are directed back through the imager field lens 118 into the pupil of a projection lens system 122 for projection of an image onto a display surface such as an image projection screen 124. The reflective imager 120 may be used in a field sequential color mode by placing a color selector such as a color wheel in the illumination light path between the light source 306 and the imager field lens 118, or by time sequencing illumination of different colors (such as light from different color producing lasers or LEDs) from light source 306 onto reflective imager 120 in synchronization with corresponding different color settings of the reflective elements of reflective imager 120.

Because of the curved surface characteristic of imager field lens 118, a portion 210b of polarized illumination light 210 from light source 306 is reflected off imager field lens 118 into the pupil of projection lens system 122. The ghost imaging of such reflected light by projection lens system 122 is, however, prevented by the placement of the linear polarizer 314 between imager field lens 122 and at least part of the projection optics of projection lens system 122. For example, if light from light source 306 is laser light linearly polarized in a direction perpendicular to the propagation direction of the laser beam and oriented at or near 90 degrees to the pass axis of the linear polarizer 314, all or substantially all of the reflected light portion 210b will be blocked from passing through polarizer 314. In such case, little if any stray light will result from passage of the reflected portion 210b through the projection lens system 122 onto the imaging surface 124. If, on the other hand, light from light source 306 is elliptically polarized with a major axis oriented at or near 90 degrees to the pass axis of polarizer 306, some but not all of the reflected light portion 210b will be blocked from passing through polarizer 314. Polarizer 314 may be placed before the projection lens system 122 or be integrated as part of the projection lens system 122. Polarizer 314 may be either absorptive or reflective, and may be configured as a flat plate, cube polarizing beam splitter, or some other configuration that provides a similar polarized light filtering functioning.

The passage of the selected portions 210c of the modulated incident light 210a that are directed back through the imager field lens 118 into the pupil of projection lens system 122 is enabled by the one-quarter wavelength retarder 312 positioned between the field lens 118 and the reflective imager 120. The retarder 312 retards the portion 210a of light 210 from light source 306 that passes in a first direction through imager field lens 118 to reflective imager 120, and again retards the selected portions 210c of the modulated light 210a that are reflected from reflective imager 120 through the imager field lens 118 in an opposite second direction along the optical path 216 into the pupil of the projection lens system 122.

The illustrated retarder 312 is a broadband quarter-wave retarder that converts linearly polarized light into circularly polarized light, and vice versa. Linearly polarized illumination light 210a reflected for projection by modulating elements of reflective imager 120 (viz., light incident on DMD mirrors set to the ON-state) passes through the quarter-wave retarder 312 twice, once before incidence and once after reflectance, resulting in a linear polarization of the projected modulated light portions 210c oriented 90 degrees to the linear polarization of the light 210 incident on field lens 118 from the polarized light source 306. Polarizer 314 at the projection lens system 122 is oriented to pass the light 210c reflected back for projection from the reflective imager 120. The unwanted light portion 210b reflected from the field lens 118 is not rotated by quarter-wave retarder 312 and is blocked by polarizer 314.

The quarter-wave retarder 312 and polarizer 314 may be arranged respectively before and after any optics between reflective imager 120 and screen 124 that can potentially produce ghost reflections from the illumination input light 210. This includes but is not limited to prisms, lenses, cover glass, or aperture masks.

FIG. 4 illustrates an example image projection system 400 which uses a total internal reflection (TIR) two-prism optical element 408 to provide normal incidence illumination through an imager field lens 118 onto a DMD reflective imager 120. In the illustrated configuration 400, polarized illumination light 210 from a polarized light source 306 directed at normal incidence to a side of prism optical element 408 is internally reflected along an optical axis 216 through imager lens 118 for normal incidence through a cover glass 411 onto a reflective element array of a packaged DMD reflective imager 120. As before, a linear polarizer 314 may be located at an entrance of or integrated within a projection lens system 122 to block projection of unwanted light reflections off optical elements positioned between light source 306 and reflective imager 120. And, as before, projection of wanted light reflected from ON-state pixel position mirrors of DMD reflective imager 120 is enabled through double passage of light to and from reflective imager 120 through a quarter-wave retarder 312 located between field lens 118 and the mirror array of reflective imager 120. However, in order to remove unwanted reflections from DMD cover glass 411 as well as from field lens 118, prism element 408 and other intervening optics elements, if any, quarter-wave retarder 312 is positioned within the DMD package, between cover glass 411 and the active DMD chip. For example, quarter-wave retarder 312 may be integrated with a surface of the cover glass facing the DMD mirror array and that defines a limit of the packaged DMD cavity.

It is noted that when prism element 408 is a polarizing beam splitter or the like, the function of polarizer 314 may be integrated within prism element 408. In this case, prism element 408 will itself reject the ghost reflections from the optics between it and the DMD 120 without the need for a separate polarizer 314. A separate polarizer 314 may be added to, if desired, to act as a clean-up polarizer to reject any remaining unwanted light that has leaked through the prism polarizing beam splitter optic, thereby further enhancing the contrast.

Those skilled in the art will appreciate that modifications may be made to the described embodiments, and also that many other embodiments are possible, within the scope of the claimed invention.

What is claimed is:

1. In an image projection system, comprising:
a light source;
a reflective imager;
a projection lens; and
an imager field lens positioned between the light source and the reflective imager, and also between the reflective imager and the projection lens system; whereby light from the light source is directed to the imager field lens for modulation by the reflective imager after passing in a first direction through the imager field lens, light modulated by the reflective imager is directed back to the imager field lens into a pupil of the projection lens after passing in a second direction opposite to the first direction through the imager field lens, and a portion of the light directed from the light source to the imager field lens is reflected off the imager field lens into the pupil of the projection lens;
the improvement comprising:
the light source being a source of polarized illumination light;
a quarter-wave retarder positioned between the imager field lens and the reflective imager for retarding light from the light source that passes through the imager field lens to the reflective imager and for retarding light from the reflective imager that passes through the imager field lens to the projection lens; and
a linear polarizer positioned between the imager field lens and the projection lens; the polarizer acting to pass light retarded by the quarter-wave retarder while passing in the first direction from the light source through the imager field lens to the reflective imager and again while passing in the second direction from the reflective imager through the imaging field lens into the pupil of the projection lens, and to block at least a portion of light reflected off the imager field lens into the pupil of the projection lens system.

2. The improvement of claim 1, wherein the light source is a source of light having a first linear polarization direction which is blocked by the linear polarizer; and wherein the quarter-wave retarder is configured to transform the light of the first linear polarization direction which passes twice through the quarter-wave retarder into light of a second linear polarization direction which is passed by the linear polarizer.

3. The improvement of claim 2, wherein the light source is a laser.

4. The improvement of claim 2, wherein the reflective imager is a digital micromirror device (DMD) reflective spatial light modulator.

5. The improvement of claim 4, wherein the DMD comprises a DMD in a package having a cover glass; and the quarter-wave retarder is located between the cover glass and a mirror array of the DMD.

6. The improvement of claim 5, further comprising a prism optical element located between the light source and the imager field lens and also located between the imager field lens and the projection lens.

7. The improvement of claim 1, wherein the reflective imager is a digital micromirror device (DMD).

8. In an image projection system, comprising:
a polarized light source;
a reflective spatial light modulator;
a projection lens;
an imager field lens positioned between the light source and the reflective imager, and also between the reflective imager and the projection lens system; whereby light from the polarized light source is directed to the imager field lens for modulation by the reflective spatial light modulator after passing in a first direction through the imager field lens, light modulated by the reflective spatial light modulator is directed back to the imager field lens into a pupil of the projection lens after passing in a second direction opposite to the first direction through the imager field lens, and a portion of the light directed from the light source to the imager field lens is reflected off the imager field lens into the pupil of the projection lens system;
a quarter-wave retarder positioned between the imager field lens and the reflective spatial light modulator for retarding light from the light source that passes through the imager field lens to the reflective spatial light modulator and for retarding light from the reflective spatial light modulator that passes through the imager field lens to the projection lens system; and
a linear polarizer positioned between the imager field lens and the projection lens; the linear polarizer acting to pass light retarded by the quarter-wave retarder while passing in the first direction from the light source through the imager field lens to the reflective spatial light modulator and again while passing in the second direction from the reflective spatial light modulator through the imaging field lens into the pupil of the projection lens, and to block at least a portion of light reflected off the imager field lens into the pupil of the projection lens system.

9. The system of claim 8, wherein the light source is a source of light having a first linear polarization direction which is blocked by the linear polarizer; and wherein the quarter-wave retarder is configured to transform the light of the first linear polarization direction which passes twice through the quarter-wave retarder into light of a second linear polarization direction which is passed by the linear polarizer.

10. The system of claim 9, wherein the polarized light source is a laser.

11. The system of claim 8, wherein the spatial light modulator is a digital micromirror device (DMD).

12. The system of claim 11, wherein the DMD comprises a DMD in a package having a cover glass; and the quarter-wave retarder is located between the cover glass and a mirror array of the DMD.

13. The system of claim 12, further comprising a prism optical element located between the light source and the imager field lens and also located between the imager field lens and the projection lens.

14. The system of claim 8, further comprising a prism optical element located between the light source and the imager field lens and also located between the imager field lens and the projection lens.

15. A method for image projection, comprising:
directing light from a polarized light source in a first direction through an imager field lens and then through a quarter-wave retarder to be incident on a reflective spatial light modulator; wherein a portion of the light directed in the first direction is reflected off the imager field lens into a pupil of a projection lens;
modulating light incident on the reflective spatial light modulator; and
directing the modulated light from the reflective spatial light modulator in a second direction opposite to the first direction through the quarter-wave retarder and then through the imager field lens into the pupil of the projection lens for projection;
wherein a linear polarizer positioned between the imager field lens and the projection lens passes light passed in the first direction from the light source through the imager field lens and quarter-wave retarder to the reflective spatial light modulator and also passed in the second direction from the reflective spatial light modulator through the quarter-wave retarder and the imaging field lens into the pupil of the projection lens, and blocks at least part of the portion of light reflected off the imager field lens traveling into the pupil of the projection lens.

16. The method of claim 15, wherein the light source is a source of laser light having a first linear polarization direction which is blocked by the linear polarizer; and wherein the quarter-wave retarder is configured to transform the laser light of the first linear polarization direction which passes twice through the quarter-wave retarder into laser light of a second linear polarization direction which is passed by the polarizer.

17. The method of claim 16, wherein the reflective spatial light modulator is a digital micromirror device (DMD) in a package having a cover glass; and the quarter-wave retarder is located between the cover glass and a mirror array of the DMD.

18. The method of claim 17, wherein directing light from a polarized light source in the first direction includes directing light from the polarized light source by internal reflection of a prism optical element between the light source and the imager field lens; and wherein directing the modulated light from the reflective spatial light modulator in the second direction includes directing the modulated light from the imager field lens by passage through the prism optical element to the projection lens.

19. The method of claim 15, wherein the reflective spatial light modulator is a digital micromirror device (DMD) in a package having a cover glass; and the quarter-wave retarder is located between the cover glass and a mirror array of the DMD.

20. The method of claim 15, wherein directing light from a polarized light source in the first direction includes directing light from the polarized light source by internal reflection of a prism optical element between the light source and the imager field lens; and wherein directing the modulated light from the reflective spatial light modulator in the second direction includes directing the modulated light from the imager field lens by passage through the prism optical element to the projection lens.
